(19) United States
(12) Patent Application Publication
(10) Pub. No.: US 2026/0331022 A1
(43) Pub. Date: Oct. 22, 2026

(54) BANDING ARTIFACT COMPENSATION SYSTEM AND METHODS

(71) Applicant: Apple Inc., Cupertino, CA (US)

(72) Inventors: Shengkui Gao, Shoreline, WA (US); Hyunsoo Kim, San Diego, CA (US); Hyunwoo Nho, Palo Alto, CA (US); Injae Hwang, Cupertino, CA (US); Marc J. DeVincentis, Palo Alto, CA (US); Patrick R. Cruce, Campbell, CA (US); Shyuan Yang, San Jose, CA (US); Tsung-Ting Tsai, San Jose, CA (US); Venkataraman V. Iyer, Sunnyvale, CA (US); Weijun Yao, Saratoga, CA (US); Yao Shi, Sunnyvale, CA (US); Yi Qiao, San Jose, CA (US); Yue Jack Chu, Cupertino, CA (US)

(21) Appl. No.: 19/563,757

(22) Filed: Mar. 11, 2026

Related U.S. Application Data
(60) Provisional application No. 63/790,399, filed on Apr. 17, 2025.

(51) Int. Cl. G09G 3/20

(52) U.S. Cl. CPC G09G 3/2092; G09G 2320/0266

(57) ABSTRACT

Electronic devices, displays, and methods are provided for compensating image data to account for banding artifacts. An electronic display may include an electronic display panel with lines and columns of display pixels and at least one impedance distorting region (IDR). Image data transmitted to pixel via lines that route around or through the IDR may be adjusted to compensate for parasitics that may be introduced by the IDR or routing around or through the IDR.

### CROSS-REFERENCE TO RELATED APPLICATIONS

This application claims priority to U.S. Provisional Patent Application No. 63/790,399 entitled “Banding Artifact Compensation Systems and Methods,” filed on Apr. 17, 2025, which is hereby incorporated by reference in its entirety for all purposes.

### SUMMARY

The present disclosure relates to compensating image data for display on an electronic display to mitigate non-uniform display panel circuitry that may adjust impedance characteristics, which may undesirably affect image data driving.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices — such as computers, mobile phones, portable media devices, tablets, televisions, virtual-reality headsets, and vehicle dashboards, among many others — often include electronic displays. To display an image, an electronic display may control light emission of its display pixels based on corresponding image data for the display pixels. By emitting light in various brightness values at different display pixels according to the image data, the electronic display may present an image.

An electronic display is often arranged in rows and columns of display pixels. Each column of display pixels is attached to a data line that is shared by all display pixels of that column. The display pixels are programmed row by row by scan and/or sampling signals that cause each display pixel of the row to briefly connect to the respective data line. In this way, the design of circuitry a panel of the electronic display may impact panel driving schemes or loading balance associated with the rows and columns. This may result in an image artifact in which the brightness of one display pixel could be affected by imbalances or interrupted transmission paths from the design of the panel.

To reduce or eliminate these image artifacts, a compensation system may be used to realize compensation operations that reduce the likelihood of an image artifact being produced. The compensation system may apply a compensation to adjust image data to be presented via a respective pixel of the electronic display. The compensation applied may be based on that location of that pixel within the panel of the electronic display. A data line and/or a scan line may be routed around an opening in the active area of the panel, such as an opening for a sensor to acquire data through. Including such a routing around in the conductive path of the data line or the scan line may cause a resistance and/or capacitance (e.g., impedance) mismatch when some data lines or scan lines are routed around opening, which may manifest as an image artifact in presented image data. Thus, the compensation system may compensate for the impedance mismatch through applying a compensation to image data to adjust the image data, which may reduce or eliminate a likelihood of the image artifact being perceivable. The display compensation system may apply zoning, such as vertical zoning and/or horizontal zoning, when compensating. Zoning may provide flexibility in the types of opening designs able to be compensated. Scaling logic of the compensation system may adapt the compensation to different panel operating conditions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display, in accordance with an embodiment;

FIG. 2 is a front view of a handheld device representing an example of the electronic device of FIG. 1, in accordance with an embodiment;

FIG. 3 is a front view of another handheld device representing another example of the electronic device of FIG. 1, in accordance with an embodiment;

FIG. 4 is a perspective view of a notebook computer representing an example of the electronic device of FIG. 1, in accordance with an embodiment;

FIG. 5 illustrates front and side views of a wearable electronic device representing another example of the electronic device of FIG. 1, in accordance with an embodiment;

FIG. 6 is a block diagram of the electronic display of FIG. 1 with display driver circuitry that includes banding artifact compensation circuitry, in accordance with an embodiment;

FIG. 7 is a diagrammatic representation of the electronic display of FIG. 1, which includes an example opening that may change a display impedance, in accordance with an embodiment;

FIG. 8 is a diagrammatic representation of the electronic display of FIG. 1, which includes an example opening and an example region that may change a display impedance, in accordance with an embodiment;

FIG. 9 is a block diagram of example banding artifact compensation circuitry of FIG. 6, in accordance with an embodiment;

FIG. 10 is a diagrammatic representation of location-based correction operations of the banding artifact compensation circuitry of FIG. 9, which may be performed based on zone definitions defining a left zone region, a right zone region, a top zone region, a bottom zone region, and a non-zone region, in accordance with an embodiment;

FIG. 11 is a diagrammatic representation of location-based correction operations of the banding artifact compensation circuitry of FIG. 9, which may be performed based on zone definitions defining a left zone region, a right zone region, a gradient region of the right zone region, and a non-gradient region of the right zone region, in accordance with an embodiment; and

FIG. 12 is a flowchart of a method for performing banding artifact compensation, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Banding artifact compensation systems and methods are described herein that may operate based on zone-based compensations, interpolation operations, or both. As one example, a display panel may include a cutout or hole to reveal a portion of underlying silicon or another portion of hardware to ambient light, ambient environmental conditions, or both, and, due to how scan lines or data lines are routed around the cutout or holes, impedances of the scan lines or data lines may be changed. When the impedance of the lines is changed, without compensation, a front of screen artifact may manifest in presented image data as a banding artifact. As described herein, banding artifact compensation systems and methods may determine a compensation to apply to incoming image data based on impedance distortions caused by regions of a display panel that may interrupt or impact driving operations of pixels of the display panel. By compensating the incoming image data using banding artifact compensation systems and methods described herein, a likelihood of the impedance distortion causing a perceivable front of screen (FOS) artifact to be reduced or eliminated. Further benefits may arise related to reducing a footprint in performing the compensation by not using dummy loading schemes to balance out panel uniformity.

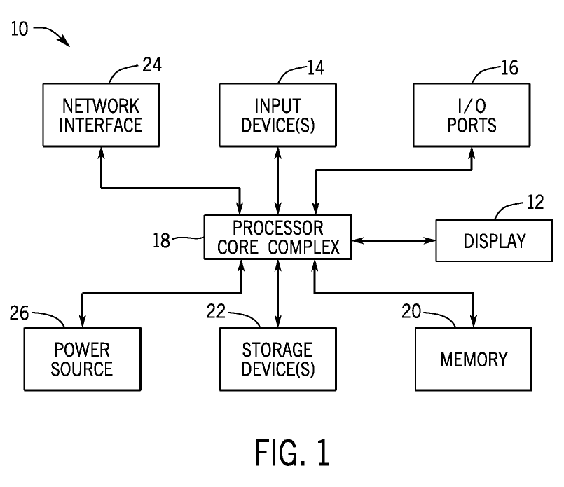

Keeping the foregoing in mind, an electronic device 10 including an electronic display 12 is shown in FIG. 1. FIG. 1 is a block diagram of an electronic device 10 with an electronic display 12. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one or more color components (e.g., red, green, or blue for an RGB pixel arrangement, red, green, blue, or white for an RGBW arrangement, or a first green component, a red component, a second green component, or a blue component for a GRGB arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

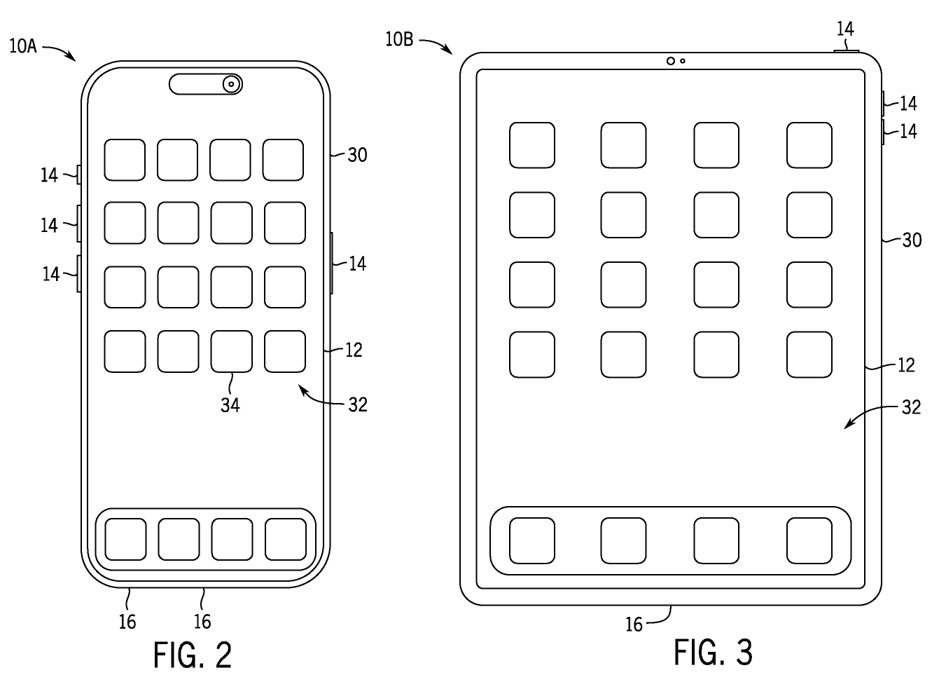

The electronic device 10 may be any suitable electronic device. To help illustrate, an example of the electronic device 10, a handheld device 10A, is shown in FIG. 2. FIG. 2 is a front view of a handheld device representing an example of the electronic device 10 of FIG. 1. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

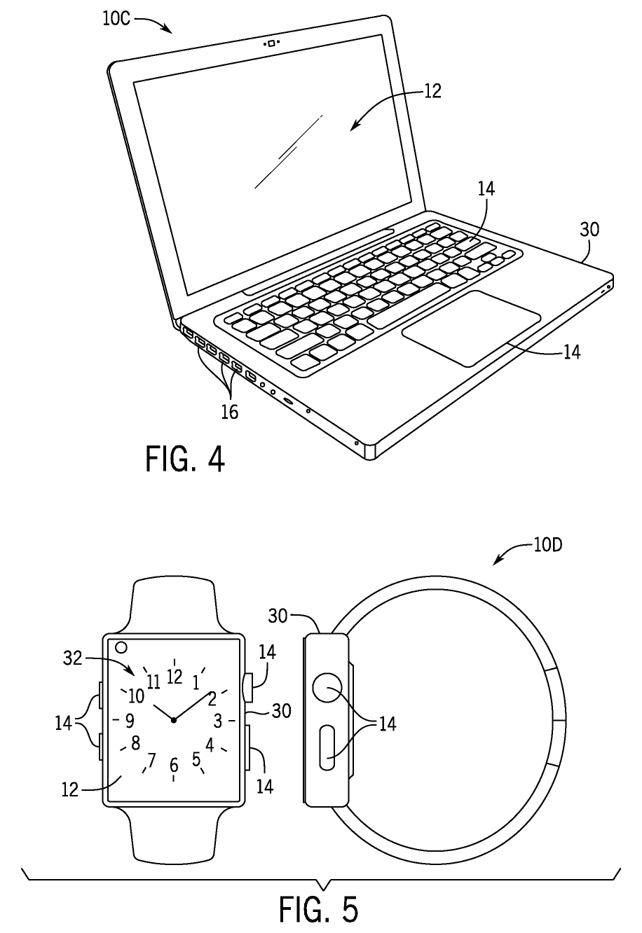

Another example of a suitable electronic device 10, specifically a tablet device 10B, is shown in FIG. 3. FIG. 3 is a front view of another handheld device representing another example of the electronic device 10 of FIG. 1. The tablet device 10B may be any IPAD® model available from Apple Inc. A further example of a suitable electronic device 10, specifically a computer 10C, is shown in FIG. 4. FIG. 4 is a perspective view of a notebook computer representing an example of the electronic device 10 of FIG. 1. For illustrative purposes, the computer 10C may be any MACBOOK® or IMAC® model available from Apple Inc. Another example of a suitable electronic device 10, specifically a watch 10D, is shown in FIG. 5. FIG. 5 illustrates front and side views of a wearable electronic device representing another example of the electronic device 10 of FIG. 1. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

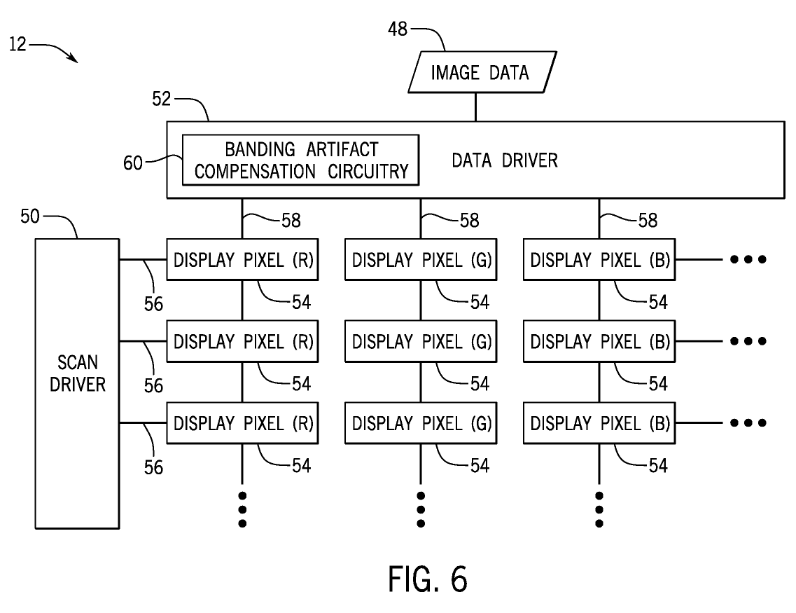

FIG. 6 is a block diagram of the electronic display 12 of FIG. 1 with display driver circuitry that includes banding artifact compensation circuitry to compensate for the presence of impedance distorting region (IDR) while preserving image quality. In FIG. 6, the electronic display 12 is shown as an electronic display 12 representing a liquid crystal display (LCD) or an organic light emitting diode (OLED) display. The electronic display 12 may receive image data 48 for display. The electronic display 12 uses display driver circuitry that includes scan driver 50 circuitry and data driver 52 circuitry to program the image data 48 onto display pixels 54. The display pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (µLEDs)). The display pixels 54 may also represent pixels of digital mirror devices (DMD) or other suitable display devices that may use pixel grouping. In any event, different display pixels 54 may emit different colors (e.g., red (R), green (G), blue (B), for an RGB display). For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress, scan, data sampling) on scan lines 56 to activate the display pixels 54 by row. For example, the scan driver 50 circuitry may cause one or more selected rows of the display pixels 54 to become enabled to receive a portion of the image data 48 from data lines 58 from the data driver 52. As used herein, the portion of image data 48 received by display pixels 54 may be referred to as “image data” or “pixel data.” An image frame of image data 48, containing pixel data for the display pixels 54, may be programmed onto the display pixels 54 row by row or selected groups of rows.

With the foregoing in mind, the display pixels 54 may be disposed on a display panel in an active area. The active area may include impedance distorting regions (IDRs), such as openings, like holes or notches, or other regions of variability in the active area, like regions of lower or different pixel densities, regions that include non-linear routing, or the like. The IDRs may impact panel driving schemes and loading balance. For example, a region that has a different number of pixels, or density, than outside the region may cause scan line driving loading difference and/or data line resistance mismatch in a row-to-row base, which may lead to luminance or color differences across the display panel. Depending on the design of the active area, display brightness and/or color may be impacted around a display opening. As such, the display driver circuitry (e.g., the data driver 52) may include banding artifact compensation circuitry 60 to adjust the image data before it is programmed into the display pixels 54. The banding artifact compensation circuitry 60 may operate based on a row-based or column-based compensation kernel or circuitry. The banding artifact compensation circuitry 60 may compensate for the presence of one or more IDRs based on vertical zoning data, horizontal zoning data, or both, which may enable compensation of a wide variety of display designs. The banding artifact compensation circuitry 60 may compensate for the presence of one or more IDRs based on scaling logic, which may adapt compensation performed to different panel conditions. The banding artifact compensation circuitry 60 may apply an adjustment in a linear, gamma domain, or a voltage domain of the image data 48. After adjustment, when programmed into the display pixels 54, image artifacts (e.g., banding artifacts) due to IDRs of the electronic display 12 may be reduced or eliminated. While the banding artifact compensation circuitry 60 is shown in FIG. 6 as a component of the display driver circuitry of the electronic display 12, in other examples, the banding artifact compensation circuitry 60 may be disposed in other circuitry, such as image processing circuitry (e.g., a display pipeline) associated with the processor core complex 18.

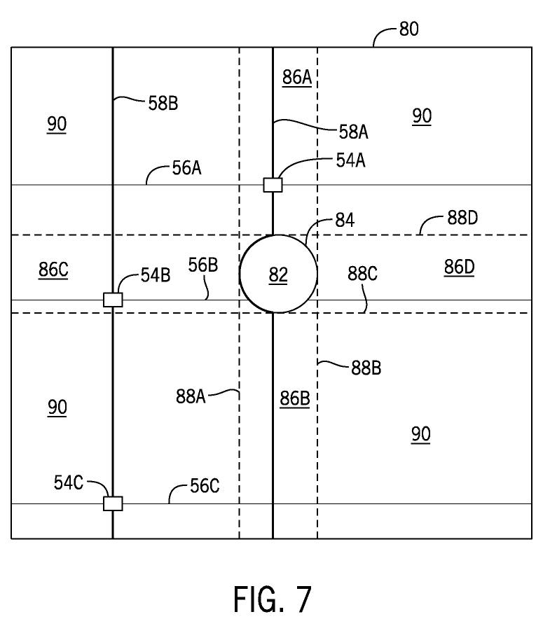

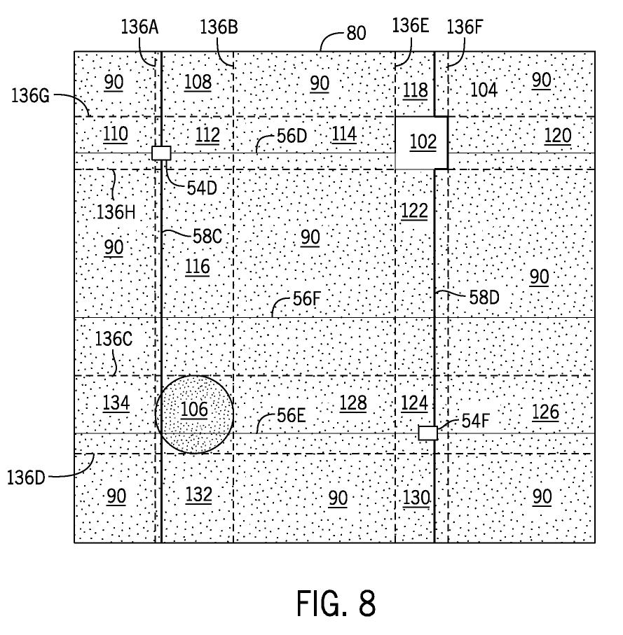

FIGS. 7-8 illustrate example mechanisms by which IDRs may affect a display pixel 54. FIG. 7 is a diagrammatic representation of the electronic display 12 of FIG. 1, which includes an example region (e.g., impedance distorting region (IDR)) that may change a driving impedance. FIG. 8 is a diagrammatic representation of the electronic display 12 of FIG. 1, which includes two example regions (e.g., impedance distorting regions (IDRs)) that may change a driving impedance. In both FIGS. 7-8, illustrated signal lines may be driven using single-ended or dual-ended designs. Compensations applied may adjust image data 48 values, a voltage applied to a signal line to adjust a characteristic of the single-ended driving operations or dual-ended driving operations, or both. Opening 82 and opening 102 are described relative to FIGS. 7 and 8. However, it should be noted that any suitable IDR may be included in a design and compensated based on systems and methods described herein. For example, a regions of impedance distortion may include one or more panel openings, one or more panel holes, one or more panel notches, one or more different pixel density regions, one or more fanout regions, one or more non-linear routing regions, or the like.

Referring to FIG. 7, an active area 80 may include an opening 82. The active area 80 may be disposed or formed in a physical material, such as silicon. The active area 80 may be formed from a physical material layer defined by an outer material edge and an inner material edge of an edge 84. The opening 82 may be negative space or a hole from a first face, or first side, of the physical material to a second face, or second side, of the physical material. The opening 82 may be defined by an edge 84 around the opening 82. The edge 84 may be a material edge or end of the physical material forming or holding the active area 80.

The active area 80 may include multiple display pixels 54. The active area 80 may include scan lines 56 and data lines 58. Each display pixel 54 may not have its own data line 58. Multiple display pixels 54 may share a single data line 58. A cross section may be used to program respective display pixels 54 with image data 48. When a data line 58 is toggled for a certain display pixel 54 in a vertical direction, a gate signal, via a scan line 56, may be transmitted to that display pixel 54 to activate for data programming. This process may be sensitive to changes in impedances as relatively tight timing windows may be used to coordinate sending of the image data 48 and activation of the display pixel 54 for programming of the sent image data 48.

One or more scan lines 56, one or more data lines 58, or both may be routed around the opening 82. For example, both data line 58A and scan line 56B are routed around the opening 82, such as following the edge 84. A respective signal line may be routed in a non-linear manner, or include non-linear routing, that curves around the opening 82 while another respective signal line is routed in a linear manner. For example, while a portion of the scan line 56B includes non-linear routing, or a curved conductive path, the scan line 56A and scan line 56C includes all linear routing without a portion that curves around the opening 82. Also illustrated is a data line 58A with linear routing that does not curve around the opening 82, a data line 58B with non-linear routing that curves around the opening 82. These are example data lines 58 and scan lines 56 and it should be understood that in an actual implementation of the electronic display 12 more than two lines of both may be used.

The curved portion of either signal line may be described as a curve portion disposed along a subset of an inner material edge of the physical material layer of the active area 80. For example, a curved portion of the data line 58A may be disposed along a subset of the inner material edge 84 of the active area 80.

When a scan line 56 or a data line 58 is routed around or through an opening 82 or another type of IDR, an impedance characterizing that scan line 56 or that data line 58 may change based on introduction of resistance (R), capacitance (C), inductance (L), or the like. Routing the signal lines in this way may introduce capacitive, resistive, or both (RC) coupling. For example, an impedance characterizing the data line 58B may negligibly differ from an impedance characterizing the data line 58A. An impedance characterizing the scan line 56C may negligibly differ from an impedance characterizing the scan line 56A. However, an impedance characterizing the scan line 56B may non-negligibly (e.g., differ as to have a measurable or perceivable impact on performance or characteristic of operation) differ from the impedance characterizing the scan line 56A due to the scan line 56B including a curved portion disposed around the edge 84 of the opening 82 and the scan line 56A including linear routing that does not route around or through a IDR. If left uncompensated, banding artifacts may appear in presented image content, which may arise from the change in impedance affecting the timing windows of data programming. For example, RC loading may affect scan line 56 characteristics and a left-to-right side delta in routing or characteristics may disrupt routing of scan line 56 signals (e.g., gate signals, signals transmitted via scan lines). This may cause a storage capacitor of the display pixel 54 to have less time to transmit the data signal from the data line 58 into it based on the driving signal from the scan line 56 that enables the display pixel 54 for programming. For example, a timing window available for programming the display pixel 54B may be shorter than a timing window available for programming the display pixel 54C based on a non-negligible difference in impedances characterizing the scan line 56C and the scan line 56B. To reduce a likelihood of banding artifacts, the banding artifact compensation circuitry 60 may compensate for the presence of one or more IDRs based on vertical zoning data and/or horizontal zoning data.

To elaborate, the banding artifact compensation circuitry 60 may compensate for the banding artifacts based on zone regions 86 (zone region 86A, zone region 86B, zone region 86C, zone region 86D). The zone regions 86 may correspond to the opening 82. When the active area 80 includes one or more IDRs, like one or more openings 82, one or more zone regions 86 may be defined relative to those IDRs. Two IDRs may correspond to eight zone regions 86, three IDRs may correspond to twelve zone regions 86, and so on. Less than four zone regions 86 may be defined per IDR. For example, two zone regions 86 may correspond to the opening 82 in some examples without including each of the four zone regions 86 depicted in FIG. 7.

Zone regions 86 may help define which compensations are applied to which pixels. The zone region 86A may be a top zone region, or a zone disposed in a region above the opening 82. The zone region 86B may be a bottom zone region, or a zone disposed in a region below the opening 82. The zone region 86C may be a left zone region, or a zone disposed in a region to the left of the opening 82. The zone region 86D may be a right zone region, or a zone disposed in a region to the right of the opening 82. Zone regions 86 may be defined based on logical boundaries 88. Logical boundaries may be defined relative to row numbers or column numbers, which may reduce an amount of computing resources expended in performing the compensation by enabling low complexity comparison of a location of a pixel within the pixel array to the logical boundaries 88 (logical boundary 88A, logical boundary 88B, logical boundary 88C, logical boundary 88D) to identify which zone region 86 includes the display pixel 54. Zone regions 86A and 86B may be defined as between the logic boundary 88A and the logical boundary 88B. Zone regions 86C and 86D may be defined as between the logic boundary 88C and the logical boundary 88D. The display pixel 54C may have no compensation applied by the banding artifact compensation circuitry 60 as the display pixel 54C is located outside of the zone regions 86 and in a region 90. Data to be sent to display pixel 54A may have zone region 86A compensations applied. Data to be sent to display pixel 54B may have zone region 86C compensations applied. In FIG. 7, none of the zone regions 86 overlap and the active area 80 may include a same density of pixels. However, in FIG. 8, multiple zone regions 86 overlap due to overlapping arrangements of logical boundaries 88 of different IDRs, one of which includes a region of differing density of pixels.

Referring to FIG. 8, an active area 100 may include an opening 102. The active area 100 may be similar to the active area 80 and thus may be disposed or formed in a physical material, such as silicon. The opening 102 may be negative space or a hole from a first face, or first side, of the physical material to a second face, or second side, of the physical material. The opening 102 illustrates a square, and it should be understood that any suitable shape of opening may be used as the opening 102 (or the opening 82), such as a rectangle, an oval, a star, a pill-shaped geometry, any multi-sided geometry, or the like. The opening 102 may be disposed at any location within the active area 100. The opening 102 may be defined by an edge 104 around the opening 102. The edge 104 may be a material edge or end of the physical material forming or holding the active area 100.

The active area 100 may also include a region 106 having a different pixel density (e.g., IDR) than the rest of active area 100. The active area 100 may have a first pixel density and the region 106 may have a second pixel density. As the region 106 may not be negative space nor form a hole within the physical material of the board of the electronic display 12, scan lines 56 and/or data lines 58 may be routed through the region 106. For example, the data line 58C and the scan line 56E may be routed at least partially through the region 106. The region 106 and the opening 102 may form asymmetries in the display panel design, which may contribute to the banding artifact.

Similar to zone regions 86, zone regions of FIG. 8 (zone region 108, zone region 110, zone region 112, zone region 114, zone region 116, zone region 118, zone region 120, zone region 122, zone region 124, zone region 126, zone region 128, zone region 130, zone region 132, zone region 134) may be defined via logical boundaries and may be otherwise similar to the zone regions 86, so descriptions from FIG. 7 are relied upon herein and may not repeated herein for brevity’s sake. Zones may be defined based on the opening 102 and the region 106. When a targeted pixel is at a location where zones overlap, the banding artifact compensation circuitry 60 may apply both opening-related and region-related compensations to image data 48 to be used to program the targeted pixel.

To elaborate, zones 108, 112, and 116 may correspond to a top zone of the region 106. Zone regions 128, 124, and 126 may correspond to a right zone region of the region 106. Zone region 132 may correspond to a bottom zone region of the region 106. Zone 134 may correspond to a left zone of the region 106. Zone regions 108, 112, 116, and 132 of the region 106 may be defined as between logical boundary 136A and logical boundary 136B. Zone regions 124, 126, 128, and 134 of the zone region 106 may be defined as between logical boundary 136C and logical boundary 136D.

To elaborate, zone region 118 may correspond to a top zone region of the opening 102. Zone region 120 may correspond to a right zone region of the opening 102. Zone regions 122, 124, and 130 may correspond to a bottom zone region of the opening 102. Zone regions 110, 112, and 114 may correspond to a left zone region of the opening 102. Zone regions 118, 122, 124, 130 of the opening 102 may be defined as between logical boundary 136E and logical boundary 136F. Zone regions 110, 112, 114, 120 of the region 106 may be defined as between logical boundary 136G and logical boundary 136H.

Regions 90 may be outside of the zone regions of FIG. 8 (zone region 108, zone region 110, zone region 112, zone region 114, zone region 116, zone region 118, zone region 120, zone region 122, zone region 124, zone region 126, zone region 128, zone region 130, zone region 132, zone region 134). Display pixels 54 located in a respective region 90 may not have image data 48 adjusted by the banding artifact compensation circuitry 60. Display pixels 54 located in one of zone region 112 or zone region 124 may have image data 48 adjusted by the banding artifact compensation circuitry 60 to compensate for impedance distortions introduced by both the opening 102 and the region 106. For example, image data 48 destined for the display pixel 54F may be adjusted to compensate for an impedance distortion introduced by the data line 58D being routed around the opening 102 and to compensate for an impedance distortion introduced by the scan line 56E being routed through the region 106 of differing pixel density. As another example, image data 48 destined for the display pixel 54D may be adjusted to compensate for an impedance change introduced by the scan line 56D being routed around the opening 102 and to compensate for an impedance change introduced by the data line 58C being routed through the region 106 of differing pixel density. It is noted that the impedance characterizing the scan line 56D may be non-negligibly different from the impedance characterizing the scan line 56F due to the scan line 56D including a portion curved or routed around the edge 104 of the opening 102. Furthermore, the impedance characterizing the scan line 56E may be non-negligibly different from the impedance characterizing the scan line 56F due to the scan line 56E including a portion routed through the region 106.

With the foregoing in mind, the banding artifact compensation circuitry 60 may adjust image data 48 designated to be presented by a respective display pixel 54, such as the display pixel 54D. The banding artifact compensation circuitry 60 may transmit the adjusted image data 48, which may lead to the adjusted image data 48 being transmitted to the display pixel 54D via the data line 58C. The scan line 56D may be arranged perpendicular to the data line 58C at the display pixel 54D to control access to a programming capacitor of the display pixel 54D at a switch (not illustrated). A zone definition that includes the location of the display pixel 54D may implicate a portion of the data line 58C (and of scan line 56D) without implicating a second portion of the data line 58C (and of scan line 56D). In other words, a compensation applied to image data 48 for a display pixel 54 located in zone region 112 may be different from that applied to a display pixel 54 located in zone region 116, even though the display pixels 54 may share a data line 58C, based on the zone region 112 being within logical boundaries 136G and 136H associated with the opening 102.

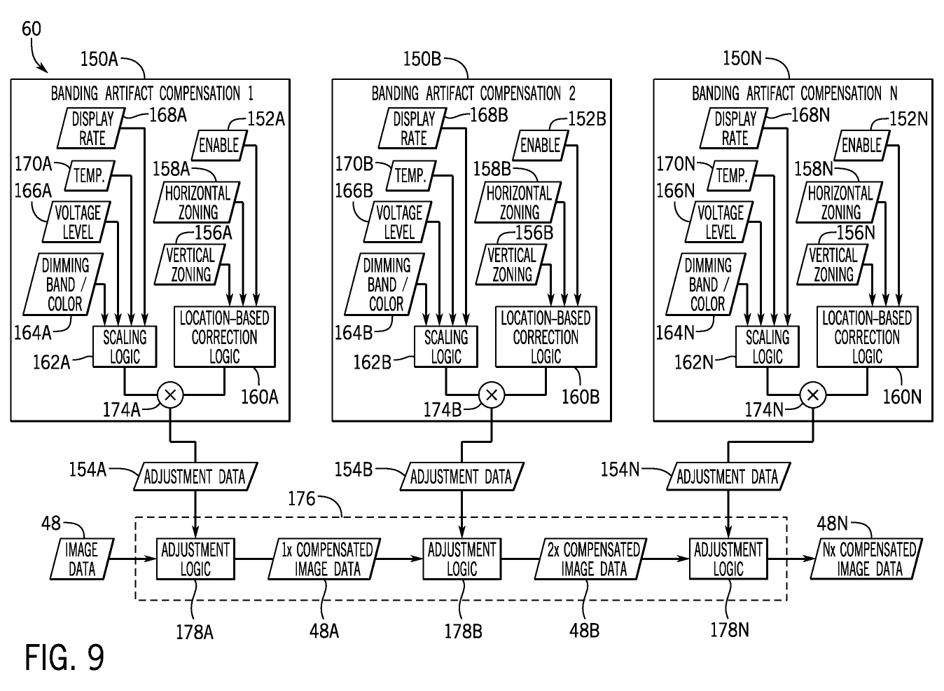

The zones of FIG. 7 and/or of FIG. 8 may be applied by the banding artifact compensation circuitry 60 to manage what compensations to apply to which display pixels 54. The banding artifact compensation circuitry 60 may additionally perform interpolations over data associated with respective columns (or rows) associated within logical boundaries of respective zones as a way to obtain adjustment data to apply to image data 48. Furthermore, the banding artifact compensation circuitry 60 may adapt compensation performed to different panel conditions based on scaling logic. After compensations are performed, the banding artifact compensation circuitry 60 may send the adjusted image data 48 for programming into a display pixel 54, such as sending for additional display driver operations. Example systems and methods to identify and apply adjustments to the image data 48 are illustrated in FIGS. 9-12.

To elaborate, FIG. 9 is a block diagram of example banding artifact compensation circuitry 60 of FIG. 6. The processor core complex 18 may include one or more processors, one or more processing resources, or other computing device able to provide the banding artifact compensation circuitry 60. The processor core complex 18 may execute instructions stored in the local memory 20 that, when executed by the processor core complex 18, provide the banding artifact compensation circuitry 60 able to adjust image data 48 for the pixel based on a location of the pixel being in a logical zone adjacent to an IDR. The banding artifact compensation circuitry 60 is described herein as performing the compensation. However, it should be understood that one or more portions of the processor core complex 18 may perform the compensation as part of providing the banding artifact compensation circuitry 60. For example, the banding artifact compensation circuitry 60 may operate based on a row-based or column-based compensation kernel or circuitry, such as banding artifact compensation circuitries 150. In some systems, the electronic device 10 may include circuitry to provide the banding artifact compensation circuitry 60. In some systems, a mix of hardware and software of the electronic device 10 is used to provide the banding artifact compensation circuitry 60.

In this illustrated example, N number of banding artifact compensation circuitries 150 (banding artifact compensation circuitry 150A, banding artifact compensation circuitry 150B, banding artifact compensation circuitry 150N). Each IDR of the active area 100 may correspond to a different of one or more banding artifact compensation circuitries 150. For example, banding artifact compensation circuitry 150A may compensate for impedance distortions arising from a first opening, banding artifact compensation circuitry 150B may compensate for impedance distortions arising from a second opening, and banding artifact compensation circuitry 150N may compensate for impedance distortions arising from a first region of different pixel density. Each of the banding artifact compensation circuitries 150 may be a display opening compensation unit (DOCU) able to handle opening cause loading mismatch uniformity compensations. Enable signals 152 may be used to enable or disable respective of the banding artifact compensation circuitries 150 based on what combination of zone-based compensations are to be applied to image data 48 of a targeted display pixel 54. For example, referring back to FIG. 8, display pixel 54F may be compensated based on first banding artifact compensation circuitry (e.g., banding artifact compensation circuitry 150A) enabled with a first enable signal (e.g., enable signal 152A) and based on second banding artifact compensation circuitry (e.g., banding artifact compensation circuitry 150B) enabled with a second enable signal (e.g., enable signal 152B) when the first and second banding artifact compensation circuitries are associated with the two compensations to be applied to the zone 124.

Referring now to operation of a respective banding artifact compensation circuitry 150A, once enabled, the banding artifact compensation circuitry 150A may generate adjustment data 154A. The banding artifact compensation circuitry 150A may generate adjustment data 154A based on vertical zoning data 156A and horizontal zoning data 158A applied to a location-based correction logic 160A.

The vertical zoning data 156 may identify zones or regions logically designated as a zone. For example, the vertical zoning data 156A may define logical boundaries of the zones of a first opening or region corresponding to the banding artifact compensation circuitry 150A. The zones may include a top zone, a bottom zone, a left zone, a right zone, or the like. A number of zones may relate to a geometry of the opening 82, the opening 102, or the region 106. For example, the two widest points of the geometry in the horizonal axis and in the vertical axis may define a boundary of respective zones. The vertical zoning data 156A may include software configurations to be applied when the location-based correction logic 160 is enabled or disabled in response to the enable signal 152A. The location-based correction logic 160A being disabled may correspond to a bypass state in which an adjustment otherwise applied at the corresponding adjustment logic 178 (adjustment logic 178A, adjustment logic 178B, adjustment logic 178N) is bypassed and not applied. The various adjustment logic 178 may include circuitry or embedded applications in memory that, when executed by processing circuitry, adjust respective image data 48 based on respective adjustment data 154 to increase or decrease a value associated with the image data 48 (e.g., color of the image data 48, hue, luminance, or the like of the image data 48), thereby changing a characteristic of the image data 48 to compensate for an effect that a respective IRD has on that image data 48.

The horizontal zoning data 158 may define specific tapping points for each dedicated zone. Location information of the horizontal zoning data 158 may be vertical zone specific or may be defined relative to vertical zones.

Each of the banding artifact compensation circuitries 150 may generate adjustment data 154 based on scaling logic 162. The banding artifact compensation circuitry 150 may compensate for the presence of one or more IDRs based on the scaling logic 162, which may adapt compensation performed to different panel conditions. The different panel conditions may be represented through one or more of the following: dimming band data or color band data 164, voltage level data 166, display refresh rate data 168, or temperature data 170. The dimming band data or color band data 164 may indicate an adjustment to be made to a scalar adjustment value to compensate for a luminance or color quality of the electronic display 12. The voltage level data 166 may indicate an adjustment to be made to a scalar adjustment value to compensate for a voltage level of the electronic display 12. The display refresh rate data 168 may indicate an adjustment to be made to a scalar adjustment value to compensate for refresh rate of the electronic display 12, where the adjustment to the scalar adjustment value may change based on the refresh rate setting of the electronic display 12. For example, a refresh rate of 60 hertz may correspond to a first scalar adjustment value and a refresh rate of 120 hertz may correspond to a second scalar adjustment value double or half the first scalar adjustment value. The temperature data 170 may indicate an ambient temperature of the electronic display 12. A temperature sensor may acquire the temperature data. The temperature sensor may be disposed on the DDIC, system on chip (SOC), or display panel silicon associated with providing the banding artifact compensation circuitry 150. The banding artifact compensation circuitry 150 may generate output data from the scaling logic 162 based on a lookup table generated during a calibration operation during manufacturing. The lookup table may store a relationship between the output data relative to different values of the dimming band data or the color band data 164, the voltage level data 166, the display refresh rate data 168, or the temperature data 170, or any combination thereof.

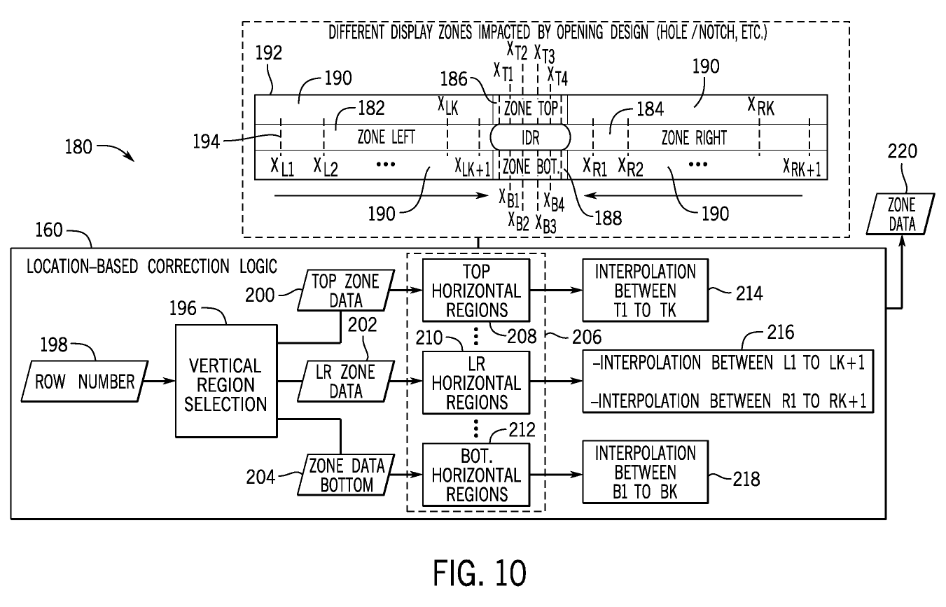

The banding artifact compensation circuitry 150 may compensate for the presence of one or more IDRs based on vertical zoning data 156A, horizontal zoning data 158A, or both, which may enable compensation of a wide variety of display designs. The vertical zoning data 156A and the horizontal zoning data 158A may correspond to indications of the zones of FIGS. 7-8, logical boundary definitions of FIGS. 7-8, relationships between respective pixel locations or regions of pixel locations relative to zone assignments, or the like. In some cases, the vertical zoning data 156A and the horizontal zoning data 158A may correspond to zone data received for an interpolation operation, such as those described relative to FIG. 10. In these cases, the processor core complex 18 may access one or more of indications of the zones of FIGS. 7-8, logical boundary definitions of FIGS. 7-8, relationships between respective pixel locations or regions of pixel locations relative to zone assignments, or the like to identify which of the banding artifact compensation circuitries 60 to enable or disable through the enable signals 152. In some systems, the banding artifact compensation circuitries 150 may perform interpolations over data associated with respective columns (or rows) associated within logical boundaries of respective zones as a way to obtain adjustment data to apply to image data 48. FIG. 10 illustrates an example interpolation.

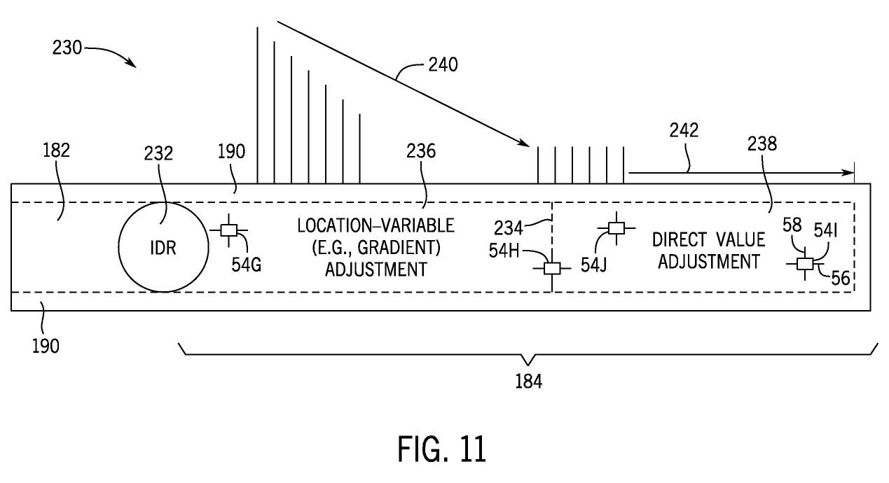

In some systems, the banding artifact compensation circuitry 150 may apply different compensations to different portions of a zone or to different zones. For example, the banding artifact compensation circuitry 150 may apply a gradient compensation relative to different locations within a first zone and may apply a scalar compensation relative to any location in a second zone. FIG. 11 illustrates an example of a mixed compensation.

An output from the scaling logic 162A may be combined with an output from the location-based correction logic 160A at combinational logic 174 (e.g., multiplier logic). The outputs may be multiplied, added, or otherwise combined to generate the adjustment data 154A. Adjustment data 154, when applied to the image data 48, may adjust the image data 48, where the adjustment data 154 is generated based on zone data from the location-based correction logic 160 and a scalar value from scaling logic 162. The adjustment data 154 may be any suitable format, such as a scalar value or a matrix value, which may be used if image data 48 of more than one pixel or more than one bit is used as the image data 48. The adjustment data 154A may be a scalar value to be applied to the image data 48 in a digital domain, an analog domain, a grey domain, or the like. The output from the scaling logic 162 may be a scalar value that may be combined with a matrix output from the location-based correction logic 160 at combinational logic 174 to generate a matrix of the adjustment data 154A. In systems where multiple banding artifact compensation circuitries 60 are enabled and used, the image data 48 may be repeatedly adjusted based on respective adjustment data 154 from each of the enable banding artifact compensation circuitries 60, resulting in Nx compensated image data 48N. For example, when each is enabled, the image data 48 may be adjusted based on adjustment data 154A at adjustment logic 182A to generate the image data 48A, the image data 48A may be adjusted based on adjustment data 154B at adjustment logic 182B to generate the image data 48B, and the image data 48B may be adjusted based on adjustment data 154N at adjustment logic 182N to generate the image data 48N, where the image data 48N has been sequentially processed through layering of banding artifact compensation adjustments.

As noted above, the vertical zoning data 156A and the horizontal zoning data 158A may correspond to zone data received for an interpolation operation. An example of the interpolation operation is described relative to FIG. 10.

Referring now to FIG. 10, FIG. 10 is a diagrammatic representation 180 of location-based correction operations of the banding artifact compensation circuitry 60 of FIG. 9, which may be performed based on zone definitions defining a left zone 182 region, a right zone region 184, a top zone region 186, a bottom zone region 188, and a non-zone region 190. Operations of the vertical region selection logic 196 may be performed relative to a respective IDR. In a system with two or more regions of impedance distortion, multiple vertical region selection logics 196 may perform respective operations for the respective regions of the multiple regions.

Active area 192 may include scan lines 56 and data lines 58 (not illustrated, described earlier at least relative to FIGS. 6-8). Columns (represented by indications like column indication 194) of the active area 192 may correspond data lines, pixel columns, or another generally repeated column structure throughout the active area. The columns may correspond to zone data or parameters that vary between one or more of the columns. The zone data or parameters may indicate different impact from the opening design or region on image data 48 presented via pixels in the display zones.

The location-based correction logic 160 of the banding artifact compensation circuitry 150 may include vertical region selection logic 196. The vertical region selection logic 196 may receive row number data 198. The row number data 198 may indicate respective row numbers of the active area 192. The row numbers may define relative positions of target display pixels 54 within the electronic display 12 active area 192 for compensation application.

The vertical region selection logic 196 may generate top zone data 200, left and/or right zone data (e.g., LR zone data 202), and bottom zone data 204. This data may be respectively applied to region processing logic 206, which may include top horizontal region processing logic 208, left and/or right horizontal region processing logic (e.g., LR horizontal region processing logic 210), and bottom horizontal region processing logic 212. LR horizontal region processing logic 210 may include two separate processing pipelines, one for left zone data and another for right zone data, or in some systems the same processing pipeline if the left zone and the right zone are symmetrical in compensation to be applied.

The region processing logic 206 may respectively interpolate the columns of data associated with the zones 182-188. For example, the top horizontal region processing logic 208 may interpolate data between T1 to Tk corresponding to columns XT1 to XT4 as part of an interpolation operation 214. The left-right horizontal region processing logic 210 may, for left region processing, interpolate data between L1 to LK+1 corresponding to columns XL1 to XLK+1 or may, for right region processing, interpolate data between R1 to RK+1 corresponding to columns XR1 to XRK+1 as part of interpolation operations 216. The bottom horizontal region processing logic 212 may interpolate data between B1 to BK corresponding to columns XB1 to XB4 as part of an interpolation operation 218. In some systems, the vertical region selection logic 196 may generate the zone data 220 based on respective interpolation operations corresponding to one or more zones affecting the row number. The one or more zones may include a zone top. The vertical region selection logic 196 may identify one or more top horizontal regions and interpolate, for each top horizontal region of the one or more top horizontal regions, between a first column (e.g., XT1) to a last column (e.g., XT4 or XTK) of that zone top horizontal region. The one or more zones may include a zone left/right. The vertical region selection logic 196 may identify one or more left/right horizontal regions and interpolate, for each left/right horizontal region of the one or more left/right horizontal regions, between a first column (e.g., XR1, XL1) to a last column (e.g., XRK+1, XLK+1) of that left/right horizontal region, where the zone left/right is a zone adjacent and left or right of an IDR. The one or more zones may include a zone bottom. The vertical region selection logic 196 may identify one or more bottom horizontal regions and interpolate, for each bottom horizontal region of the one or more bottom horizontal regions, between a first column (e.g., XB1) to a last column (e.g., XBK, XB4) of that zone bottom horizontal region.

The interpolation result from the respective region processing logic 206 may be output to combinational logic 174 as zone data 220. The combinational logic 174 may combine the zone data 220 with output data from the scaling logic 162 to generate the adjustment data 154. As described above, respective banding artifact compensation circuitries 150 may apply respective adjustment data 154 to the image data 48. When more than one region or opening is being compensated, each of the banding artifact compensation circuitries 150 may operate sequentially to adjust the image data 48, such as in a compensation pipeline 176 illustrated in FIG. 9. Adjusting sequentially may improve compensation operations by increasing modularity of the adjustments and/or reducing complexity of adjusting the compensation for changes in an active area design, which may reduce costs associated with an actual implementation or associated with updating an actual implementation as design revisions or newer versions are released.

As noted above, the banding artifact compensation circuitry 60 may apply a gradient compensation relative to different locations within a first zone and may apply a scalar compensation relative to any location in a second zone. An example of the mixed compensation is described relative to FIG. 11.

FIG. 11 is a diagrammatic representation of location-based correction logic 160 operations of the banding artifact compensation circuitry 150 of FIG. 9, which may be performed based on zone definitions defining a left zone region 182, a right zone region, a gradient region of the right zone region, and a non-gradient region of the right zone region. The zone definitions mirror those used in FIG. 10 for ease of explanation and are similarly defined relative to an IDR 232.

Location-based correction logic 160 of FIGS. 9-10 may apply generate different zone data based on where a display pixel 54 is located within a respective zone. As illustrated, each display pixel 54 is associated with combination of a scan line 56 and a data line 58, as described above. The location-based correction logic 160 may divide or band a zone into regions and generate zone data based on the different regions to drive or cause different compensations to be applied to image data 48 destined to pixels in the different regions. For example, the right zone region 184 may be divided into two or more zones at a boundary definition 234, such as a first sub-zone 236 and a second sub-zone 238. Image data 48 to be presented via the display pixel 54G may be adjusted differently than image data 48 to be presented via the display pixel 54I or the display pixel 54H based on how the display pixel 54G is located to the left of the boundary definition 234 within the first sub-zone 236. Likewise, the display pixel 54I may be adjusted differently than image data 48 to be presented via the display pixel 54I or the display pixel 54G based on how the display pixel 54G is located to the right of the boundary definition 234 within the second sub-zone 236.

The location-based correction logic 160 may define the first sub-zone 236 and the second sub-zone 238 with a same range of row numbers as the right zone region 184. However, the location-based correction logic 160 may define the first sub-zone 236 with a range of column numbers distinct from a range of column numbers used to define the second sub-zone 238, as vice versa. For example. the location-based correction logic 160 may define the first sub-zone 236 with a range of column numbers from XR1 to a column number of the boundary definition 234. The location-based correction logic 160 may define the second sub-zone 238 with a range of column numbers from the column number of the boundary definition 234 to XRK+1, which represents a right material edge of the active area 192 in the example of FIG. 10. For a boundary case, such as display pixel 54H that lies on in the column number of the boundary definition 234, the location-based correction logic 160 may generate zone data to apply a third compensation for that boundary condition pixel, may generate zone data corresponding based on operations of the first sub-zone 236, may generate zone data corresponding based on operations of the second sub-zone 236, or may interpolate between zone data generated for an adjacent column relative to the boundary condition row, where the adjacent column may be a next adjacent column (e.g., C+1 or C-1, where C represents a column number of the boundary definition 234) of the boundary definition 234 column or within a threshold number of columns from the boundary definition 234 column (e.g., C+Z or C-Z, where C represents a column number of the boundary definition 234 and where Z represents the threshold number).

The location-based correction logic 160 may generate zone data based on different operations for different zones or sub-zones. For example, the left zone region 182 may correspond to different generated zone data than the right zone region 184 based on the data being processed in the operations of FIG. 10, in the operations performed to generate the zone data, such as in the operations being performed to generate direct fill data, location-variable (e.g., gradient fill) data, or both in different regions or sub-regions, or the like. For example, the location-based correction logic 160 may generate zone data for the first sub-zone 236 corresponding to a gradient value fill. As another example, the location-based correction logic 160 may generate zone data for the second sub-zone 236 corresponding to a gradient value fill. The location-based correction logic 160 may apply operations to generate the zone data of gradient value fill when the display pixel 54 is located in a sub-zone of a zone region, when the pixel is located in a zone region, or both.

In FIG. 11, the location-based correction logic 160 may generate zone data based on different operations for the left zone region 182 and the right zone region 184, as well as based on the different sub-zones 236, 238 of the right zone region 184. It is noted that although described here relative to left zone region 182 and right zone region 184, it should be understood that zone-dependent or sub-zone dependent compensations may be applied or used relative to any zone definition, such as relative to top zone region 186, bottom zone region 188, or other suitable zone definitions not described herein.

As an example, the location-based correction logic 160 may generate zone data to apply a location variable adjustment to image data 48 destined for the display pixel 54G located in the first sub-zone 236 of the right zone region 184. Gradient diagrammatic representation 240 illustrates as an example how zone data 220 generated may vary in value between column numbers of that respective zone. The location-variable or gradient adjustment may lead to variable zone data 220 produced between different column numbers or row numbers, between row numbers or column numbers of a same or different image frame, or the like. The variance may be location-based or temporal, such as over time or over different or repeated image frames. The location variable adjustment or gradient adjustment may correspond to variable, location-based operation where image data 48 destinated for display pixels 54 of the first sub-zone 236 are adjusted based on zone data that varies based on the location of that display pixel 54 within the first sub-zone 236.

As another example, the location-based correction logic 160 may generate zone data to apply a direct value adjustment to image data 48 destined for the display pixel 54I located in the second sub-zone 238 of the right zone region 184. The direct value adjustment may correspond to a non-variable, non-location-based operation where image data 48 destinated for display pixels 54 of the second sub-zone 238 are adjusted based on a same zone data regardless of the actual pixel location in the second sub-zone 238. Here, based on the direct value adjustment, constant zone data 220 is illustrated via linear diagrammatic representation 242 as unchanged across the second sub-zone 238. The direct value adjustment of the second sub-zone 238 may lead to the location-based correction logic 160 generating the same zone data for the display pixel 54I as the display pixel 54J, even though the display pixel 54J is in a different row number and column number relative to the display pixel 54I.

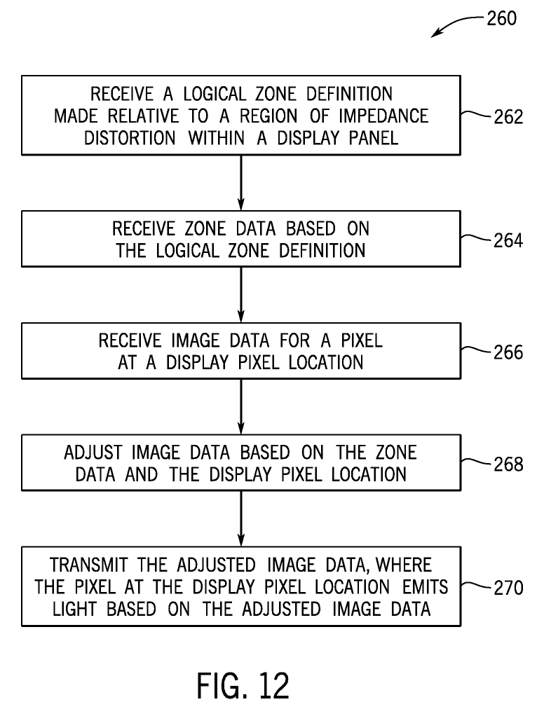

With the foregoing in mind, FIG. 12 is a flowchart of a method 260 for performing banding artifact compensation. The method 260 is described herein as being performed by the banding artifact compensation circuitry 60, which may be provided by one or more processing resources of the processor core complex 18. It should be understood that any suitable processing circuitry of the electronic device 10 may perform some or all of the operation of the method 260. For example, the processor core complex 18 may perform the method 260 to perform banding artifact compensation. As another example, the electronic device 10 may include processing circuitry associated with the processor core complex 18, which may include local memory, such as a tangible, non-transitory, computer-readable medium with instructions that, when executed by the processing circuitry, cause the electronic device 10 to perform banding artifact compensation operations via the banding artifact compensation circuitry 60 and operations of the method 260. The banding artifact compensation circuitry 60 may be disposed in or provided via circuitry of a display pipeline of the electronic device 10. The banding artifact compensation circuitry 60 may be disposed in or provided via circuitry of a data driver 52 or scan driver 50 of the electronic device 10. Although operations are described herein in a particular order, it should be understood that in some implementations a different order may be used.

At block 262, the banding artifact compensation circuitry 60 may receive a logical zone definition made relative to one or more IDRs within a display panel. The logical zone definition may indicate logical boundaries of a top zone region, a left zone region, a right zone region, and/or a bottom zone region. The logical zone definition may include in it a pixel at a display pixel location. A display panel or active area of the electronic display 12 may include the IDR and a curved portion of a data line 58 disposed around an edge of the IDR. For example, the IDR may correspond to the opening 82 with the edge 84 or any other opening or region that adjusts an impedance as described herein. The IDR may include pixels disposed with a first pixel density, where the active area or a second region of the active area may include pixels disposed with a second pixel density that differs from the first pixel density. For example, relative to zone region 124 of FIG. 8 and the display pixel 54F, the logical zone definition may indicate a first zone that the display pixel 54 is in (e.g., bottom zone region generally of the opening 102 of FIG. 8), a second zone the display pixel is in (e.g., right zone region generally of the region 106 of FIG. 8), and an overlap of the first zone and the second zone (e.g., zone 124) at the location of the display pixel (e.g., display pixel 54F).

At block 264, the banding artifact compensation circuitry 60 may receive zone data 220 based on the logical zone definition. The zone data 220 may include a scalar value corresponding to a direct fill adjustment like that described relative to second sub-zone 238 in FIG. 11. For example, the zone data 220 may indicate a percentage by which to reduce red data of the image data 48, a scalar value by which to increase green data of the image data 48 by, or any suitable adjustment. The zone data 220 may include a scalar value corresponding to a location-variable or gradient adjustment like that described relative to first sub-zone 236 in FIG. 11. The zone data 220 may include data associated with a respective portion of columns within the logical zone definition generated based on interpolating respective values of each of the data.

At block 266, the banding artifact compensation circuitry 60 may receive image data 48 for a pixel at a display pixel location (e.g., a first location). The banding artifact compensation circuitry 60 may receive the image data 48 to be adjusted based on the adjustment data 154. For example, the image data 48 received at block 266 may be received from an image source for original processing, may be received from other image processing circuitry (e.g., display pipeline, image processing SOC, display pipeline SOC) and thus may have already undergone one or more image processing operations. The banding artifact compensation circuitry 60 may receive the display pixel location before receiving the image data 48. As such, one or more of the operations of the method 260 may be performed in parallel to one or more other operations to enable at least some amount of pipelining of the operations, which may reduce time spent performing the compensations and/or may enable more efficient consumption of resources when performing the operations of method 260.

At block 268, the banding artifact compensation circuitry 60 may adjust image data 48 based on the zone data 220. The banding artifact compensation circuitry 60 may adjust the image data 48 based on the adjustment data 154 at the adjustment logic 178. For example, the zone data 220 may be generated based on an interpolation operation and thus adjusting the image data 48 based on the zone data 220 may involve applying an interpolation result to change the value of the image data 48. The adjustment logic 178 may subtract, add, multiply, divide, interpolate, or perform any suitable computational operation to combine the adjustment data 154 with the image data 48 to generate compensated image data 48, such as 1x compensated image data 48A, 2x compensated image data 48B, or Nx compensated image data 48N, depending on a number of other adjustments performed to the image data 48.

At block 270, the banding artifact compensation circuitry 60 may transmit the adjusted image data 48, where the display pixel 54 at the display pixel location may emit light based on the adjusted image data 48. The display pixel 54 at the display pixel location may emit light according to the adjusted image data 48 being programmed into storage of the display pixel 54, such as loaded into a storage capacitor of the pixel, into memory-in-pixel of the display pixel 54, or the like. The banding artifact compensation circuitry 60, when provided via processing circuitry of the data driver 52, may transmit the adjusted image data 48 directly to a data line 58 able to couple to the display pixel 54. The banding artifact compensation circuitry 60, when provided via processing circuitry of the scan driver 50, may transmit the adjusted image data 48 to the data driver 52, which may transmit the adjusted image data 48 to the data line 58 able to couple to the display pixel 54. The banding artifact compensation circuitry 60, when provided via image processing circuitry of the electronic device 10, such as a display pipeline implemented upstream from the data driver 52, may transmit the adjusted image data 48 to the data driver 52, which may transmit the adjusted image data 48 to the data line 58 able to couple to the display pixel 54. The data line 58 may be a signal line routed around or through one or more IDRs, such as the data line 58A in FIG. 7 routed around the opening 82 and thus disposed around an edge 84 of the opening 82 as an impedance distorting region. When this adjusted target pixel data is programmed into the target display pixel, after settling, the target display pixel may present image content substantially free of banding image artifacts arising from inclusion of one or more impedance distortion regions (e.g., openings, differing pixel density regions) in the active area.

Adjusting the image data 48 based on the zone data may include considering an output from scaling logic 162 in FIG. 9. For example, operations of the method 260 may include the banding artifact compensation circuitry 60 receiving a scalar value generated based on a temperature (e.g., temperature data 170), a refresh rate (e.g., display refresh rate data 168), a dimming band (e.g., dimming band data and/or dimming color band data 164), a dimming color (e.g., dimming band data and/or dimming color band data 164), a voltage level (e.g., voltage level data 166), or the like, or any combination thereof. The banding artifact compensation circuitry 60, at block 268, may adjust the image data 48 based on the zone data and the scalar value. To do so, the banding artifact compensation circuitry 60 may involve adding, multiplying, adjusting, or otherwise combining the zone data 220 and the scalar value output from the scaling logic 162 at the combination logic 174 to generate adjustment data 154. The banding artifact compensation circuitry 60 may adjust the image data 48 based on the adjustment data 154 (e.g., generated based on the zone data 220 and a scalar value based on a temperature, a refresh rate, or both) at the adjustment logic 178.

Operations of the method 260 may be described herein relative to a single pixel. It should be understood that the operations of the method 260 may be applied to multiple display pixels 54 to adjust image data 48 destined to respective pixels of the multiple display pixels 54. For example, at block 266, the banding artifact compensation circuitry 60 may receive image data 48 one or more display pixels 54, each associated with a respective display pixel location. Some operations described herein may be applied based on matrix-based operations that may handle and adjust image data 48 for one or more pixels. Moreover, compensation operations may dynamically change over the presentation of multiple image frames (e.g., temporally). For example, at a first time for a first image frame of image data 48 for a first pixel, the banding artifact compensation circuitry 60 may adjust the image data 48 using a first adjustment data, and, at a second time for a second image frame of image data 48 for the first pixel, the banding artifact compensation circuitry 60 may adjust the image data 48 using a second adjustment data different from the first adjustment data. As another example, the banding artifact compensation circuitry 60 may receive or access an additional pixel location within the display panel and receive or access an additional zone definition affecting the additional pixel location. The banding artifact compensation circuitry 60 may receive or access a first scalar value based on the additional zone definition and may receive or access a second scalar value based on temperature data, a refresh rate setting, or both. The banding artifact compensation circuitry 60 may adjust additional image data 48 based on the first scalar value and the second scalar value. The banding artifact compensation circuitry 60 may transmit the adjusted additional image data 48, where an additional display pixel at the additional pixel location may emit light according to the adjusted additional image data 48.

In some cases, the banding artifact compensation circuitry 60 may enable or disable different compensation circuities based on what zone regions a targeted pixel for compensation is located within. The banding artifact compensation circuitry 60 may do so through generating the enable signal 152 having a first state (to enable) or a second state (to disable). For example, the banding artifact compensation circuitry 60 may enable first compensation circuitry (e.g., banding artifact compensation circuitry 150A) and may disable second compensation circuitry (e.g., banding artifact compensation circuitry 150B), as may occur when the first compensation circuitry is associated with the display pixel location without the second compensation circuitry being associated with that location. The banding artifact compensation circuitry 60 may adjust the image data 48 at block 268 based on adjustment data 154 from the first compensation circuitry without adjustment data from the second compensation circuitry. As another example, the banding artifact compensation circuitry 60 may enable first banding artifact compensation circuitry 150 and enabling second banding artifact compensation circuitry 150 based on the first banding artifact compensation circuitry 150 and the second banding artifact compensation circuitry 150 both being associated with the zone definition received at block 262 that includes the display pixel location associated with block 266.

Before block 262, the banding artifact compensation circuitry 60 may define multiple logical zone definitions. These definitions may indicate ranges of display pixels 54 within the respective zones. For example, the banding artifact compensation circuitry 60 may identify the top zone region 186, the bottom zone region 188, the left zone region 182, and the right zone region 184 based on an indication of a location of an IDR. The banding artifact compensation circuitry 60 may define these zones, or zone regions, relative to an IDR within a display 12 panel at least in part by accessing an indication of a location, or a range of row numbers and column numbers of the active area, within the electronic display 12 panel of an opening or another IDR. When an opening is the IDR, a curved conductive path of a signal line may be disposed adjacent to the location of the IDR, such as to characterize how the signal line is routed around the material edge defining the opening. The banding artifact compensation circuitry 60 may write the zone definitions to memory for future reference as part of compensation operations. In some cases, the zone data 220 may be precalculated and stored in memory 20 relative to the zone definitions such that repeated interpolations may not be performed each time zone data 220 is generated, which may conserve or reduce costs of performing these operations.

It is noted that under active area 192 in FIG. 10 are illustrated arrows. These may represent dual-sided scan line 56 driving operations. Asymmetries or nonuniform design associated with the active area 192 arising from the presence of one or more IDRs and routing around or through the regions of IDRs may cause imbalances in load driven by respective scan lines 56. In other words, the scan driver 50 may drive two sides of the same scan line 56 row number in a dual-sided driving operation with the same signal power. When one or more IDRs are not included in the active area, loads may be balanced relative to each other and the driving operations may be the same on each size of the dual-sided driving (e.g., a same power for driving may be used). However, when one or more IDRs are included, the asymmetries in routing and circuitry may add, remove, or otherwise adjust impedances, such as resistive loads, capacitive loads, or both, associated with the driving operations. Left uncompensated and these adjustments may manifest as FOS image artifacts, such as from timing windows affecting the data is stored in the display pixel 54 after the adjustments to the impedances, as described above. Adjusting image data 48 to compensate for these image artifacts may use less silicon, take a lower footprint compared to including compensatory load balancing circuitry, and thus may be a desirable solution to removing perceivability of or compensating the image artifacts. For example, the active area 192 may correspond to a display panel that includes one or more display pixels 54, a first signal line, and a second signal line. The first signal line may include a curved conductive path routed around an edge (e.g., physical edge, logical edge) of the IDR. A first resistance may characterize the first signal line. The second signal line may include a linear conductive path that bypasses or does not route through or around the IDR. A second resistance may characterize the second signal line. Processing circuitry providing the banding artifact compensation circuitry 60 may generate or cause generation (e.g., through transmitting a control signal to driver circuitry) of a first voltage to drive the first signal line based on the first resistance. Processing circuitry providing the banding artifact compensation circuitry 60 may generate or cause generation of a second voltage to drive the second signal line based on the second resistance. By doing so, a second resistance may compensate image data 48 or driving operations for an image artifact that may arise from an imbalance in the driving operations. As another example of dual-sided driving operations, a first driver may be coupled to a first end of a first scan line 56, where the first scan line 56 may include a curved conductive path routed around an IDR or a path (curved or linear) through an IDR, and where the first scan line 56 may have a first impedance. A second driver may be coupled to a first end of second scan line 56, where the first end and a second end of the second scan line 56 may be disposed physically on the display panel in horizontal alignment with the first end and the second end of the first scan line (e.g., the second scan line does not have a route around or through the IDR). The second scan line 56 may have a second impedance. The banding artifact compensation circuitry 60 may cause the first driver to apply a different voltage to the first end of the scan line 56 than the second driver applies to the first end of the scan line 56 based on a difference between the first impedance and the second impedance.

In some cases, the banding artifact compensation circuitry 60 may dynamically define which of the one or more zones is the top zone region 186, left/right zone region 182, 184, and the bottom zone region 188 based on orientation data from a sensor, such as an orientation sensor or gyroscope sensor that generates different orientation data based on whether the electronic device 10 is orientated in landscape or portrait use mode or is rotated between the orientations.

In some cases, calibration may be performed during manufacturing. To calibrate, the electronic display 12 may be operated to present test data image content. An image may be captured of the electronic display 12 while the test data is presented. The banding artifact compensation circuitry 60 may identify regions that exceed or cross a threshold amount of variance in color, luminance, or other visual characteristic of the image content presented via the test data. Based on these regions of variance, the banding artifact compensation circuitry 60 may generate zone regions to compensate for the regions of variance. After generating the zone regions, the banding artifact compensation circuitry 60 may write zone definitions that logically define the boundaries of the zone regions relative to row numbers, column numbers, and/or regions of pixels to correspond to the regions of variance. The banding artifact compensation circuitry 60 may generate zone data 220 for one or more of the zone regions, where the zone data 220 compensates for the variance in color, luminance, or other visual characteristic of the image content presented via the test data. The zone data 220 may be written to a look-up table relative to row number, column number, or pixel regions corresponding to the zone region the zone data 220 is for. Doing so may enable the banding artifact compensation circuitry 60 to preprocess at least sone zone data 220 for later reading from memory during real-time compensation operations. Compensations to apply relative to the different zone definitions may be identified during a calibration operation based on images of image content presented via the electronic display 12 panel and identifying suitable compensations to apply to make presentation of the image content uniform or negligibly variable.

Technical effects of these systems and methods may include reducing or eliminating a likelihood of the impedance distortion causing a perceivable image artifact through compensating the incoming image data based on banding artifact compensation circuitry. The banding artifact compensation circuitry may operate based on zone-based compensations operations, interpolation operations, or both. By using both zone-based compensation operations and interpolation operations, an amount of power consumed to perform the banding artifact compensations may be reduced relative to not performing zone-based compensations, which may be due to zone-based compensations enabling selective skipping of compensations in some regions (e.g., non-zone regions may not undergo banding artifact compensations).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A device, comprising:
processing circuitry; and
local memory comprising instructions that, when executed by the processing circuitry, apply a banding artifact compensation to adjust image data for a pixel based on the pixel being disposed in a logical zone adjacent to an impedance distorting region at least in part by:
receiving zone data corresponding to the logical zone;
adjusting the image data based on the zone data; and
transmitting the adjusted image data for presentation by the pixel.

2. The device of claim 1, comprising a display panel comprising a curved portion of a data line disposed around an edge of the impedance distorting region, wherein transmitting the adjusted image data to the pixel uses the curved portion of the data line, wherein the curved portion of the data line is in the display panel.

3. The device of claim 2, wherein the display panel is formed from a material layer defined by an outer material edge and an inner material edge, and wherein the curved portion of the data line is disposed along a subset of the inner material edge.

4. The device of claim 2, wherein the impedance distorting region has a first pixel density, and wherein the display panel comprises an additional region with a second pixel density.

5. The device of claim 2, wherein the display panel comprises:
the pixel;
a first signal line, wherein the first signal line comprises a curved conductive path routed around a physical edge of the impedance distorting region, and wherein the first signal line is associated with a first resistance; and
a second signal line, wherein the second signal line comprises a linear conductive path, and wherein the second signal line is associated with a second resistance; and
wherein the processing circuitry configured to:generate a first voltage to drive the first signal line based on the first resistance; andgenerate a second voltage to drive the second signal line based on the second resistance.

6. The device of claim 1, wherein the zone data comprises a scalar value.

7. The device of claim 1, wherein the banding artifact compensation comprises:
receiving a scalar value generated based on a temperature, a refresh rate, a dimming band, a dimming color, a voltage level, or any combination thereof; and
adjusting the image data based on the zone data and the scalar value.

8. The device of claim 1, wherein adjusting the image data based on the zone data comprises adjusting the image data based on applying an interpolation result to change a value of the image data.

9. The device of claim 1, wherein the banding artifact compensation comprises enabling first compensation circuitry and disabling second compensation circuitry based on the first compensation circuitry alone being associated with the logical zone.

10. A tangible, non-transitory, computer-readable medium comprising instructions that, when executed by processing circuitry, cause an electronic device to perform banding artifact compensation operations comprising:
receiving a logical zone definition made relative to an impedance distorting region within a display panel, wherein the logical zone definition comprises a display pixel location;
receiving zone data based on interpolating between respective column values of the logical zone definition;
adjusting image data based on the zone data; and
transmitting the adjusted image data, wherein a display pixel at the display pixel location within the display panel is configured to emit light according to the adjusted image data.

11. The computer-readable medium of claim 10, wherein the operations comprise transmitting the adjusted image data to the display pixel via a first signal line, and wherein the logical zone definition implicates a portion of the first signal line without a second portion of the first signal line being implicated.

12. The computer-readable medium of claim 10, wherein the operations comprise:
generating a scalar value based on a temperature, a refresh rate, or both; and
adjusting the image data based on the zone data and the scalar value.

13. The computer-readable medium of claim 10, wherein the operations comprise enabling first compensation circuitry and disabling second compensation circuitry based on the first compensation circuitry alone being associated with the logical zone definition.

14. The computer-readable medium of claim 10, wherein the operations comprise enabling first compensation circuitry and enabling second compensation circuitry based on the first compensation circuitry and the second compensation circuitry both being associated with the logical zone definition.

15. The computer-readable medium of claim 10, wherein the operations comprise:
receiving an additional pixel location within the display panel;
receiving an additional zone definition affecting the additional pixel location;
receiving a first scalar value based on the additional zone definition;
receiving a second scalar value based on temperature data, a refresh rate setting, or both; and
adjusting additional image data based on the first scalar value and the second scalar value.

16. A system, comprising:
a display panel comprising an impedance distorting region and a display pixel;
and banding artifact compensation circuitry configured to adjust image data for the display pixel based on a location of the display pixel being in a logical zone adjacent to the impedance distorting region.

17. The system of claim 16, wherein the banding artifact compensation circuitry configured to adjust the image data based on the location of the display pixel, a first zone the display pixel is in, a second zone the display pixel is in, and an overlap of the first zone and the second zone at the location of the display pixel.

18. The system of claim 16, comprising:
a first driver coupled to a first end of a first scan line, wherein the first scan line comprises a curved conductive path routed around a physical edge of the impedance distorting region, and wherein the first scan line has a first impedance;
a second driver coupled to a first end of a second scan line, wherein the first end and a second end of the second scan line is disposed physically on the display panel in horizontal alignment with the first end and a second end of the first scan line, and wherein the second scan line has a second impedance; and
wherein the banding artifact compensation circuitry is configured to cause the first driver to apply a different voltage to the first end of the first scan line than the second driver applies to the first end of the second scan line based on a difference between the first impedance and the second impedance.

19. The system of claim 16, wherein the banding artifact compensation circuitry is configured to adjust the image data at least in part by:
receiving a first plurality of data associated with a respective portion of columns within a first zone;
generating a first zone data based on interpolating between respective values of each of the first plurality of data;
generating a scalar value based on a temperature, a refresh rate, or both; and
adjusting the image data based on the first zone data and the scalar value.

20. The system of claim 16, wherein the banding artifact compensation circuitry is configured to adjust the image data at least in part by:
receiving a first plurality of data associated with a respective portion of columns within a first zone;
generating a first zone data based on interpolating between respective values of each of the first plurality of data;
adjusting the image data based on the first zone data; and transmitting the adjusted image data to the display pixel.
